(19) United States
(12) Patent Application Publication
(10) Pub. No.: US 2021/0039976 A1
(43) Pub. Date: Feb. 11, 2021

(54) A Method and a System for Providing at Least One Input Parameter of Sludge Dewatering Process of a Wastewater Treatment Plant

(71) Applicant: Kemira Oyj, Heisinki (FI)

(72) Inventors: Samantha Kiljunen, Lappeenranta (FI); Tatjana KARPOVA, Espoo (FI); Hannele HAVANSI, Espoo (FI); Michael RECKTENWALD, Espoo (FI)

(73) Assignee: Kemira Oyj, Heisinki (FI)

(21) Appl. No.: 16/966,482

(22) PCT Filed: Jan. 31, 2019
(86) PCT No.: PCT/FI2019/050071

§ 371 Date: Jul. 31, 2020

(30) Foreign Application Priority Data
Feb. 2, 2018 (FI) 20185097

(51) Int. Cl. C02F 11/14; C02F 1/52

(52) U.S. Cl. CPC C02F 11/14; C02F 1/5245; C02F 2209/006; C02F 2209/001; C02F 1/5254

(57) ABSTRACT

The invention relates to a method for providing at least one input parameter of a sludge dewatering process of a wastewater treatment plant. The method comprises: obtaining data representing process and/or plant configuration data of said wastewater treatment plant; feeding at least part of the obtained data to at least one model formed at least by historical process and plant configuration data gathered from a plurality of wastewater treatment plants combined with properties of applied chemicals in said wastewater treatment plants; and predicting at least one input parameter and/or at least one output parameter of the sludge dewatering process by means of the at least one model for adjusting sludge dewatering process of said wastewater treatment plant. The invention relates also to a computing unit for performing at least partly the method.

### TECHNICAL FIELD

The invention concerns in general the technical field of wastewater treatment. Especially the invention concerns sludge dewatering of a wastewater treatment plant.

### BACKGROUND

A lot of waste waters are produced worldwide today. With increasing industrialization and enlarging municipal areas, the valuable water resources become even more valuable. As more wastewater is produced, more sludge for disposal is obtained. In order to be careful with the condition of the Earth providing efficient and environmentally friendly ways of using the Earth's resources is of utmost importance for the future.

When wastewaters are treated different types of sludges are obtained as byproducts depending on which type of process is used for a specific wastewater treatment plant (WWTP). The sludge obtained during a wastewater purification process may be considered a refuse or a product to be used in further processes. Independently of the classification of the sludge obtained it is often desirable to make sure that the sludge volume is decreased as much as possible to e.g. concentrate the product obtained, lower transportation costs and/or lower waste handling costs. Municipal wastewater or sewage treatment generally involves three stages, called primary, secondary and tertiary treatment.

The primary treatment is designed to remove coarse, suspended and floating solids from raw sewage. It includes screening to trap solid objects and sedimentation by gravity to remove suspended solids. This level is sometimes referred to as “mechanical treatment”, although chemicals are often used to accelerate the sedimentation process. The primary sludge may be composted, put on landfill, dewatered or dried to reduce the water content, and/or digested for methane production.

After the primary treatment, the wastewater is directed to a secondary treatment, which includes a biological treatment and removes the dissolved organic matter, phosphorus and nitrogen that escapes the primary treatment. This is achieved by microbes consuming the organic matter, and converting it to carbon dioxide, water, and energy for their own growth and reproduction. The secondary sludge may be composted, put on landfill, dewatered, dried and/or digested for methane production.

Tertiary treatment is sometimes defined as anything more than primary and secondary treatment in order to further purify the waters.

The sludge obtained in the different steps may be further decomposed, e.g. to provide biogas, and the digestate obtained may be dewatered to minimize the water content of the final solids cake obtained. For sludge downstream processing such as transport, composting, incineration, and disposal as high dry solids content as possible is desirable.

Sludge dewatering is the separation of a liquid and solid phase whereby, generally, the least possible residual moisture is required in the solid phase for the reason that the residual moisture in the dewatered solids determines the disposal costs. Nowadays main sludge dewatering solutions are mainly based on chemical conditioning of sludge followed by physical based equipment treatment.

There exist also processes that add chemicals to the sludge in order to improve the dewatering. In order to improve the dewatering of such sludges sometimes compounds, such as lime, are added which are less desirable to use from an environmental perspective. The increased sludge amount is an undesirable effect of lime treatment. Even though lime provides good dewatering properties, it is undesirable in view of the aspects that it swells and increases in volume. Addition of inorganic coagulants and flocculants to the sludge enables improved dewatering, wherein the sludge does not swell by absorption of water, as is the case for lime addition.

Typically, wastewater treatment plants in many communities or in industry are not state-of-the-art. The operation of the wastewater treatment plants often date back to the 1970s or 1980s. Thus, the operation of the wastewater treatment plants may be costly in terms of energy and chemical consumption. The process control may be done via manual adjustments of parameters, such as aeration pumps and chemical dosage, which in turn are based on manual sampling and retrospective test done on regular intervals. Furthermore, to be on the safe side with respect to contaminant limits in effluent, over-aerating and overdosing of chemicals may be common.

Typically, WWTPs may collect a high number of process and operation data for the daily operation of the plant. However, WWTPs may not effectively analyze their collected data. Some major parameters, such as consumption figures, may be used for their annual reporting. Mostly WWTPs may collect all data separately, i.e. independently, from each other. Data quantities may be collected to solve single quality issues on plant level.

Optimum operation of a WWTP reduces environmental impact and especially operation costs. Reduced operation costs may be a driver for process optimization. The focus of the cost drivers for sludge dewatering in a WWTP is the final Dry Solids (DS) for disposal. Approximately half of the operational costs of a WWTP may be caused by sludge handling and disposal. That is why the major driver for cost effectiveness on a WWTP may be cost reduction for sludge, sludge handling and its disposal.

In recent times, the focus has changed from landfilling or disposal to recycling and reuse and beneficial utilization of sludge as a renewable raw material and energy source. The focus has changed from sludge as waste to sludge as raw material. This new change imposes new requirements and maybe new regulation on the sludge properties, on the sludge as raw material. The sludge dryness still plays a major role due to: transport costs, hauling costs, energy content and energy efficiency.

### SUMMARY

An objective of the invention is to present a method and a computing unit for providing at least one input parameter of a sludge dewatering process of a wastewater treatment plant. Another objective of the invention is that the method and the computing unit for providing at least one input parameter of a sludge dewatering process of a wastewater treatment plant improve at least partly the sludge dewatering process of the wastewater treatment plant.

The objectives of the invention are reached by a method, a computing unit, a computer program, and a computer-readable medium as defined by the respective independent claims.

According to a first aspect, a method for providing at least one input parameter of a sludge dewatering process of a wastewater treatment plant is provided, wherein the method comprises: obtaining data representing process and/or plant configuration data of said wastewater treatment plant; feeding at least part of the obtained data to at least one model formed at least by historical process and plant configuration data gathered from a plurality of wastewater treatment plants combined with properties of applied chemicals in said wastewater treatment plants; and predicting at least one input parameter and/or at least one output parameter of the sludge dewatering process by means of the at least one model for adjusting sludge dewatering process of said wastewater treatment plant.

Furthermore, the provided at least one input parameter may be used to adjust the sludge dewatering process.

Moreover, the adjusting of the sludge dewatering process may cause improvement of at least one output parameter of the sludge dewatering process.

At least part of the model may use at least one of the following: mixed effect model, random decision forests, local regression, frequent itemset discovery, or association rules discovery.

The formation of the at least one model may comprise at least one of the following processing steps: categorizing data, recognizing common parameters, combining data, selecting parameters.

The at least one input parameter of the sludge dewatering process may comprise at least one of the following: flocculant type, flocculant mix ratios (of different flocculants), flocculant dosage, flocculant concentration, coagulant type, coagulant mix ratio (of different coagulants), coagulant dosage or coagulant concentration.

The at least one output parameter of the sludge dewatering process may comprise at least one of the following: sludge properties or reject water properties.

Alternatively or in addition, the at least one model may be continuously learning by using further historical process and plant configuration data obtained from the plurality of wastewater treatment plants combined with properties of applied chemicals in said wastewater treatment plants to adapt the at least one model.

The process data may comprise at least one of the following: wastewater origin, sludge origin, sludge genesis, ratio of sludge flows, incoming sludge dry solids, throughput flows, operation time, storage time of sludge before process steps, storage time of sludge after process steps, residence times, chemical dosages, nutrient composition, sludge ash content, volatile solids in the incoming sludge.

The plant configuration data may comprise at least one of the following: digester type, sludge dewatering equipment type and size, flocculant injection point, waste water treatment steps.

According to a second aspect, a computing unit for providing at least one input parameter of sludge dewatering process of a wastewater treatment plant is provided, wherein the computing unit comprising: at least one processor, and at least one memory storing for at least one portion of computer program code, wherein the at least one processor being configured to cause the computing unit at least to perform: obtain data representing process and/or plant configuration data of said wastewater treatment plant; feed at least part of the obtained data to at least one model formed at least by historical process and plant configuration data gathered from a plurality of wastewater treatment plants combined with properties of applied chemicals in said wastewater treatment plants; and predict at least one input parameter and/or one output parameter of the sludge dewatering process by means of the at least one model for adjusting sludge dewatering process of said wastewater treatment plant.

Furthermore, the computing unit may further be configured to provide the predicted at least one input parameter to a control unit of the wastewater treatment plant for adjusting the sludge dewatering process with at least one of the predicted input parameters.

Moreover, the adjusting of the sludge dewatering process may cause improvement of at least one output parameter of the sludge dewatering process.

At least part of the model may use at least one of the following: mixed effect model, random decision forests, local regression, frequent itemset discovery, or association rules discovery.

The formation of the at least one model may comprise at least one of the following processing steps: categorizing data, recognizing common parameters, combining data, selecting parameters.

The process data may comprise at least one of the following: wastewater origin, sludge origin, sludge genesis, ratio of sludge flows, incoming sludge dry solids, throughput flows, operation time, storage time of sludge before process steps, storage time of sludge after process steps, residence times, chemical dosages, nutrient composition, sludge ash content, volatile solids in the incoming sludge.

The plant configuration data may comprise at least one of the following: digester type, sludge dewatering equipment type and size, flocculant injection point, waste water treatment steps.

According to a third aspect, a computer program is provided, wherein the computer program comprises computer executable instructions configured to perform the method described above, when run in a computer, such as the computing unit.

According to a fourth aspect, a computer-readable medium is provided, wherein the computer-readable medium comprises the computer program described above, when run in a computer, such as the computing unit.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objectives and advantages thereof, will be best understood from the following description of specific embodiments when read in connection with the accompanying drawings.

### BRIEF DESCRIPTION OF FIGURES

The embodiments of the invention are illustrated by way of example, and not by way of limitation, in the figures of the accompanying drawings.

FIG. 1 illustrates schematically an exemplifying environment, wherein the embodiments of the invention may be implemented.

FIG. 2 illustrates schematically an example of a method according to the invention.

FIG. 3 illustrates schematically an example of a computing unit according to the invention.

### DESCRIPTION OF SOME EMBODIMENTS

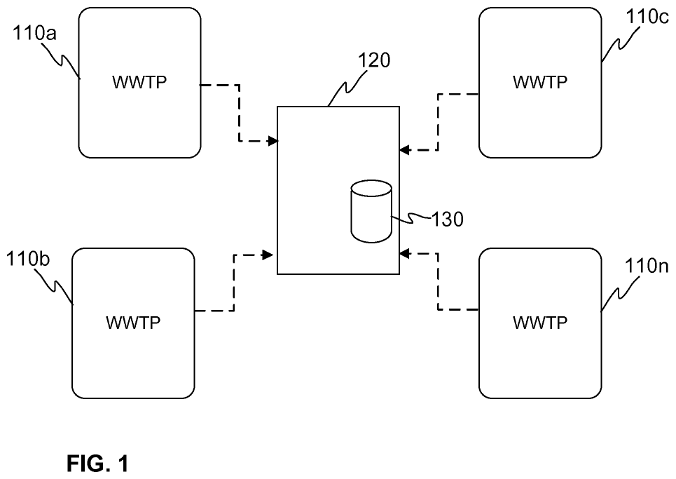

FIG. 1 illustrates schematically a simple example of an environment, wherein the embodiments of the invention may be implemented as will be described. The environment may comprise a plurality wastewater treatment plants (WWTP) 110a-110n and a computing unit 120. The example environment illustrated in FIG. 1 comprises four WWTPs 110a-110n, but the number of WWTPs is not limited. Each of the plurality of WWTPs 110a-110n operates independently, i.e. separately, from each other, so that each of the plurality of WWTPs 110a-110n comprises a control unit for controlling the operation of the WWTP. Furthermore, each of the plurality of WWTPs 110a-110n may collect independently, i.e. separately, from each other a high number of process and configuration data during its operation. The computing unit 120 may comprise a database 130 for storing the process and configuration data of all or at least some of the plurality of WWTPs 110a-110n. The database 130 may be either internal or external to the computing unit 120, but in all cases accessible by the computing unit 120. In FIG. 1 the database 130 is illustrated as an internal database.

Hence, the database 130 comprises a historical, i.e. long-term, process and configuration data of a plurality of WWTPs 110a-110n gathered over a long period of time. The long period of time may be, for example, days, weeks, months or years. Moreover, the historical data may be updated continuously by storing recent, i.e. new, data of the plurality of WWTPs 110a-110n into the database 130 as further process and configuration data is gathered from the plurality of WWTPs 110a-110n. The historical process and configuration data stored in the database 130 comprises a huge amount of information about the operation and dynamics of the processes of the plurality of WWTPs 110a-110n that may be used for providing at least one model for predicting at least one input parameter and/or at least one output parameter of sludge dewatering process of individual WWTPs. For example, the at least one input parameter and/or at least one output parameter of sludge dewatering process of WWTP 110a may be predicted by using historical process and configuration data of the plurality of WWTPs 110a-110n together with other data as will be described later.

The historical process data may comprise at least one of the following: wastewater origin, sludge origin, sludge genesis, ratio of sludge flows, incoming sludge dry solids, throughput flows, operation time, storage time of sludge before process steps, storage time of sludge after process steps, residence times, chemical dosages, nutrient composition, sludge ash content, volatile solids in the incoming sludge. The historical plant configuration data, in turn, may comprise at least one of the following: digester type, sludge dewatering equipment type and size, flocculant injection point, sludge genesis, waste water treatment steps, e.g. primary, secondary and/or tertiary treatment and digestion. The above lists for historical process data and historical plant configuration data are only non-limiting examples and they may comprise also any other data representing historical process data or historical plant configuration data. Furthermore, the historical process and plant configuration data may be different for different WWTPs.

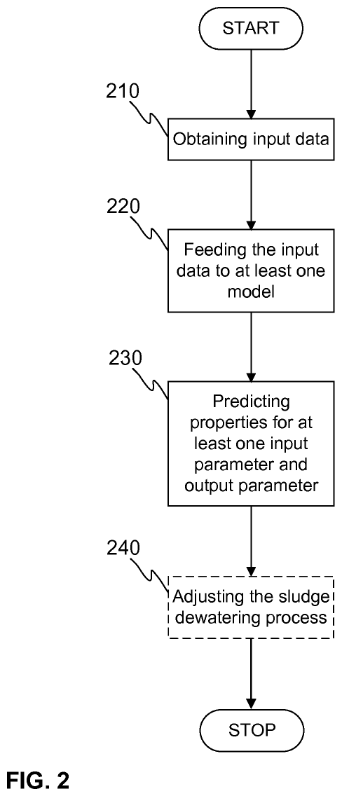

Next an example of a method according to the invention is described by referring to FIG. 2. FIG. 2 schematically illustrates the invention as a flow chart. First, the computing unit obtains 210 data representing process and/or configuration data of the WWTP in question, i.e. the WWTP for which the at least one input parameter and/or at least one output parameter of sludge dewatering process will be predicted, e.g. WWTP 110a. The data representing process and/or configuration data of the WWTP may be obtained from the WWTP, e.g. from an operator of the WWTP, or from a database to which the input data may be stored. The database may be the database 130 or any other database.

Next, the computing unit feeds 220 at least part of the obtained data to at least one model formed at least by historical process and plant configuration data gathered from a plurality of WWTPs 110a-110n combined with properties of applied chemicals in said WWTP. The chemicals are added to the sludge to improve the dewatering process. Some non-limiting example properties of applied chemicals are: molecular weight, structure (e.g. linear, branched), viscosity, charge (anionic, cationic, neutral, amphoteric), charge level (e.g. charge mole percentage, charge density) or appearance (e.g. dry, emulsion) of polymers, typically of flocculant and/or coagulant polymers, metal type (e.g. aluminium, iron), acidity, basicity, counter ion of inorganic materials, typically inorganic coagulants, salt content, amount of insoluble particles, particle size distribution.

Chemicals typically used at a WWTP comprise at least one of coagulant and flocculant. Flocculants may often be polymers. Coagulants may typically be polymers or inorganic coagulants.

Inorganic coagulants may be e.g. one or more of salts of aluminum, iron, magnesium, calcium, zirconium and zinc, or any combination thereof; preferably one or more of e.g. chlorides, and sulphates, and any combination thereof; and preferably calcium chloride, calcium sulphate, zinc chlorides, iron chlorides, iron sulphates, aluminium chlorides, and aluminium sulphates, and any com-bination thereof.

Inorganic coagulants may comprise one or more of ferrous chloride, ferric chloride, ferrous sulphate, ferric sulphate, ferrous chlorosulphate, ferric chlorosulphate, polyferrous sulphate, polyferric sulphate, polyferrous chloride, poly-ferric chloride, polyaluminium sulphate, polyaluminium chloride, polyferrous aluminium chloride, polyferric aluminium chloride, polyferrous aluminium sulphate, and polyferric aluminium sulphate, and any combination thereof.

Polymers used in a waste waters treatment plant may be polymers may be cationic, anionic, nonionic, or amphoteric. Polymers may comprise e.g. polyacrylamide, polyamine, polydiallyldimethylammoniumchloride (polyDADMAC), melamine formaldehydes, natural polymers, natural polysaccharides, and cationic or anionic derivatives thereof, and any combination thereof; preferably polymers is selected from polyacrylamide, polyamine and polyDADMAC, and any combinations thereof.

The computing unit predicts 230 at least one input parameter and/or at least one output parameter of the sludge dewatering process by means of the model for adjusting the sludge dewatering process of said WWTP. The at least one predicted input parameter or output parameter may be formed by either multiple simultaneous or consecutive calls to the model. With the predicted at least one input parameter and/or at least one output parameter e.g. the sludge dryness may be at least partly increased, i.e. the amount of free water in the dewatered sludge may be at least partly decreased. The amount of remaining free water in the dewatered sludge defines the sludge dryness and thus also the costs caused by the sludge handling and disposal. Hence, the invention also enables decreasing the costs caused by the sludge handling and disposal, e.g. transportation costs.

The at least one input parameter of the sludge dewatering process may be, for example, one of the following: flocculant type, flocculant mix ratios (of different flocculants), flocculant dosage, flocculant concentration, coagulant type, coagulant concentration, coagulant mix ratios (of different flocculants), coagulant dosage. The at least one output parameter of the sludge dewatering process may be, for example, one of the following: sludge properties, e.g. solids content of the sludge (sludge dryness), sludge stickiness; reject water properties, e.g. turbidity, color, odor, particle size, particle size distribution, particle concentration.

In an embodiment, as a predicted input parameter the flocculant type may be related to e.g. molecular weight or viscosity, structure (e.g. linear, branched), charge (anionic, cationic, neutral, amphoteric), charge level (e.g. charge mole percentage or charge density) or appearance (e.g. dry, emulsion) of a flocculant, typically flocculant polymer.

In an embodiment, as a predicted input parameter the coagulant type may be related to molecular weight or viscosity, charge (cationic, amphoteric), charge level (e.g. charge mole percentage or charge density) or appearance (e.g. dry, solution) of coagulant polymer(s); metal type (e.g. aluminium, iron), acidity, basicity of inorganic coagulants.

Furthermore, the provided, i.e. predicted, at least one input parameter may be used to adjust 240 the sludge dewatering process of said WWTP. In order to adjust the sludge dewatering process of said WWTP the at least one input parameter may be provided, i.e. delivered, to an operator of the WWTP and/or to a control unit of the WWTP in order to adjust the sludge dewatering process of said WWTP. Alternatively, the computing unit 120 may generate a control signal comprising information representing the at least one predicted input parameter to a control unit of the WWTP to adjust the sludge dewatering process of said WWTP with the at least one of the predicted input parameters. If the computing unit 120 is communicatively connected to the control unit of WWTP, said computing unit 120 may be a localized computing unit that may get updates from a centralized computing unit comprising the model and the database.

At least part of the model may use, for example, at least one of the following: mixed effect model, random decision forests, local regression, frequent itemset discovery, or association rules discovery. The mixed effect model may be linear or non-linear. Preferably, at least one model is used to predict each input parameter and each output parameter. Selection of appropriate model for predicting a specific parameter may depend on the input data. Mixed effect model and random decision forests may be used to predict numeric parameters. Mixed effect model has fixed effects, which apply over the complete data, and random effects, which apply to a subset of the data, wherein the data is the historical process data and plant configuration data gathered from a plurality of wastewater treatment plants combined with properties of applied chemicals in said wastewater treatment plants, i.e. data that is used to form the model. Mixed effects may also be interactions between the parameters. Interaction may also be slope, i.e. intercepting variables may have also different slopes according to the values of the variables. Some numeric parameter values used in a model may be learned from the smooth curve fitted with local regression over historical data. Random decision forests, frequent itemset discovery or association rules discovery may be used for making prediction or recommendation of non-numeric parameters or quantized versions of continuous numeric parameters. As described above the at least one model is formed at least by using historical process and plant configuration data gathered from a plurality of WWTPs 110a-110n combined with properties of applied chemicals in said WWTP. The formation of the at least one model may comprise, for example, at least one of the following processing steps: combining data, categorizing data, selecting parameters, recognizing common parameters. Each processing step may be performed one or multiple times in the formation of the at least one model. According to an example, the at least one model may be stored in the memory 330 of the computing unit 120.

Alternatively or in addition, the at least one model may be continuously learning by using further historical process and plant configuration data obtained from the plurality of WWTPs combined with properties of applied chemicals in said WWTP to adapt the at least one model. Automatic data validation may be performed prior to using the further historical process data and plant configuration data for continuous learning of the at least one model.

The method according to the invention described above may be implemented independently, i.e. separately, for any one of the plurality of the WWTPs 110a-110n. This enables that the historical data gathered from the plurality of the WWTPs together with the data of an individual WWTP may be used to adjust the sludge dewatering process of the individual WWTP. The adjusting of the sludge dewatering process may cause improvement of at least one of the output parameters of the sludge dewatering process, but the simultaneous improvement of all output parameters of the sludge dewatering process is not necessarily needed. According to one example of the invention the predicted at least one input parameter may be used to adjust the sludge dewatering process to improve or optimize a specific, i.e. particular, at least one output parameter of the sludge dewatering process.

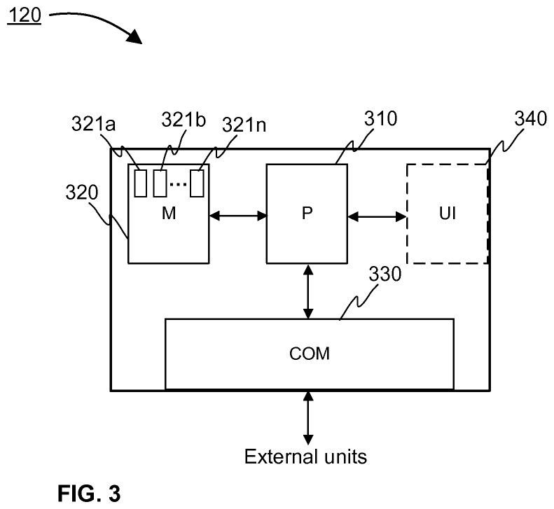

FIG. 3 illustrates a schematic example of a computing unit 120 according to the invention. Some non-limiting examples of the computing unit 120 may e.g. be a server, personal computer, laptop computer, tablet computer, mobile phone, computing circuit, a network of computing devices. The computing unit 120 may comprise at least one processor 310, at least one memory 320 for storing portions of computer program code 321a-321n and any data values, a communication interface 330, and possibly one or more user interface units 340. The computing unit 120 may further comprise the database 130 as described. The mentioned elements may be communicatively coupled to each other with e.g. an internal bus. For sake of clarity, the processor herein refers to any unit suitable for processing information and control the operation of the computing unit 120, among other tasks. The operations may also be implemented with a microcontroller solution with embedded software. Similarly, the at least one memory 320 is not limited to a certain type of memory only, but any memory type suitable for storing the described pieces of information may be applied in the context of the present invention. Furthermore, the at least one memory may be volatile or non-volatile.

The processor 310 of the computing unit 120 is at least configured to implement at least some method steps as described. The implementation of the method may be achieved by arranging the processor 310 to execute at least one computer executable instruction defined in at least some portion of computer program code 321a-321n contained in a computer-readable medium, e.g. the memory 320, causing the processor 310, and thus the computing unit 120, to implement one or more method steps as described. The processor 310 is thus arranged to access the memory 320 and retrieve and store any information therefrom and thereto. The communication interface 330 provides interface for communication with any external unit, such as control units of WWTPs 110a-110n, the database 130, and/or other external systems. The communication interface 330 may be based on one or more known communication technologies, either wired or wireless, in order to exchange pieces of information as described earlier. Moreover, the processor 310 is configured to control the communication through the communication interface 330 with any external unit. The processor 310 may also be configured to control storing of received and delivered information.

The specific examples provided in the description given above should not be construed as limiting the applicability and/or the interpretation of the appended claims. Lists and groups of examples provided in the description given above are not exhaustive unless otherwise explicitly stated.

1. A method for providing at least one input parameter and/or at least one output parameter of a sludge dewatering process of a wastewater treatment plant, wherein the method comprises:
obtaining data representing process data and/or plant configuration data of said wastewater treatment plant,
feeding at least part of the obtained data to at least one model formed at least by historical process data and plant configuration data gathered from a plurality of wastewater treatment plants combined with properties of applied chemicals in said wastewater treatment plants, and
predicting at least one input parameter and/or at least one output parameter of the sludge dewatering process by means of the at least one model for adjusting sludge dewatering process of said wastewater treatment plant.

2. The method according to claim 1, wherein the provided at least one input parameter is used to adjust the sludge dewatering process.

3. The method according to claim 2, wherein the adjusting of the sludge dewatering process causes improvement of at least one output parameter of the sludge dewatering process.

4. The method according to claim 1, wherein at least part of the model uses at least one of the following: mixed effect model, random decision forests, local regression, frequent itemset discovery, or association rules discovery.

5. The method according to claim 1, wherein the formation of the at least one model comprises at least one of the following processing steps: categorizing data, recognizing common parameters, combining data, selecting parameters.

6. The method according to claim 1, wherein the at least one input parameter of the sludge dewatering process comprises at least one of the following: flocculant type, flocculant mix ratios, flocculant dosage, flocculant concentration, coagulant type, coagulant mix ratios, coagulant dosage or coagulant concentration.

7. The method according to claim 1, wherein the at least one output parameter of the sludge dewatering process comprises at least one of the following: sludge properties, such as sludge dryness, sludge stickiness, or reject water properties, such as turbidity, color, odor, particle size, particle size distribution, particle concentration.

8. The method according to claim 1, wherein the at least one model is continuously learning by using further historical process data and plant configuration data obtained from the plurality of wastewater treatment plants combined with properties of applied chemicals in said wastewater treatment plants to adapt the at least one model.

9. The method according to claim 1, wherein the process data comprises at least one of the following: wastewater origin, sludge origin, sludge genesis, ratio of sludge flows, incoming sludge dry solids, throughput flows, operation time, storage time of sludge before process steps, storage time of sludge after process steps, residence times, chemical dosages, nutrient composition, sludge ash content, volatile solids in the incoming sludge.

10. The method according to claim 1, wherein the plant configuration data comprises at least one of the following: digester type, sludge dewatering equipment type and size, flocculant injection point, waste water treatment steps.

11. A computing unit for providing at least one input parameter and/or one output parameter of sludge dewatering process of a wastewater treatment plant, the computing unit comprising:
at least one processor, and
at least one memory storing for at least one portion of computer program code,
wherein the at least one processor being configured to cause the computing unit at least to perform:
obtain data representing process data and/or plant configuration data of said wastewater treatment plant,
feed at least part of the obtained data to at least one model formed at least by historical process data and plant configuration data gathered from a plurality of wastewater treatment plants combined with properties of applied chemicals in said wastewater treatment plants, and
predict at least one input parameter and/or one output parameter of the sludge dewatering process by means of the at least one model for adjusting sludge dewatering process of said wastewater treatment plant.

12. The computing unit according to claim 11, wherein the computing unit is further configured to provide the predicted at least one input parameter to a control unit of the wastewater treatment plant for adjusting the sludge dewatering process with at least one of the predicted input parameters.

13. The computing unit according to claim 12, wherein the adjusting of the sludge dewatering process causes improvement of at least one output parameter of the sludge dewatering process.

14. The computing unit according to claim 11, wherein at least part of the model uses at least one of the following: mixed effect model, random decision forests, local regression, frequent itemset discovery, or association rules discovery.

15. The computing unit according to claim 11, wherein the formation of the at least one model comprises at least one of the following processing steps: categorizing data, recognizing common parameters, combining data, selecting parameters.

16. The computing unit according to claim 11, wherein the process data comprises at least one of the following: wastewater origin, sludge origin, sludge genesis, ratio of sludge flows, incoming sludge dry solids, throughput flows, operation time, storage time of sludge before process steps, storage time of sludge after process steps, residence times, chemical dosages, nutrient composition, sludge ash content, volatile solids in the incoming sludge.

17. The computing unit according to claim 11, wherein the plant configuration data comprises at least one of the following: digester type, sludge dewatering equipment type and size, flocculant injection point, waste water treatment steps.

18. A computer program comprising computer executable instructions configured to perform the method of claim 1.

19. A computer-readable medium comprising the computer program of claim 18.
